(19) United States
(12) Patent Application Publication
(10) Pub. No.: US 2005/0281558 A1
(43) Pub. Date: Dec. 22, 2005

(54) Flexible band tunable add/drop multiplexer and modular optical node architecture

(75) Inventors: Ting Wang, Princeton, NJ (US); Philip Nan Ji, Princeton, NJ (US); Lane Zong, Plainsboro, NJ (US); Osamu Matsuda, Chiba (JP)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/093,516

(22) Filed: Mar. 30, 2005

Related U.S. Application Data
(60) Provisional application No. 60/580,777, filed on Jun. 18, 2004.

(51) Int. Cl. H04J 14/02

(52) U.S. Cl. 398/85

(57) ABSTRACT

An improved optical add/drop multiplexer design is disclosed which utilizes flexible band tunable filters and colorless demultiplexers to process any contiguous group of channels. A modular optical add/drop architecture is also disclosed which allows additional processing capabilities to be added module by module in a cost-effective fashion.

This application claims the benefit of U.S. Provisional Application No. 60/580,777, filed on Jun. 18, 2004, the contents of which is hereby incorporated by reference.

This application is related to U.S. application Ser. No. 10/810,632, entitled ‘FLEXIBLE BAND TUNABLE FILTER,’ filed on Mar. 26, 2004, which is incorporated by reference herein.

### BACKGROUND OF THE INVENTION

The present invention relates generally to optical communications, and, more particularly, to add/drop multiplexers for use in optical communications.

A leading technology for use in next generation high-speed communication networks has been wavelength division multiplexing (WDM) or its variations such as Dense-WDM. See, e.g., M. S. Borella, J. P. Jue, D. Banerjee, et al., ‘Optical Components for WDM Lightwave Networks,’ Proceedings of the IEEE, Vol. 85, No. 8, pp. 1274-1307, August 1997, the contents of which are incorporated by reference herein. In a WDM system, multiple signal sources are emitted at different wavelengths and multiplexed onto a common optical medium, where each wavelength band represents a separate channel. An optical add/drop multiplexer (OADM) selectively adds/drops one or more wavelengths to/from the multiple channels multiplexed on an optical fiber and is an indispensable component of a WDM network.

A variety of different OADM architectures have been disclosed in the prior art. See, e.g., P. S. Andre et al., ‘Tunable Transparent and Cost Effective Optical Add-Drop Multiplexer Based on Fiber Bragg Grating for DWDM Networks,’ Tu D1.1, 2001 IEEE Digest of LEOS Summer Topical Meetings (2001); P. Tang et al., ‘Rapidly Tunable Optical Add-Drop Multiplexer (OADM) Using a Static-Strain-Induced Grating in LiNbO3,’ IEEE J. of Lightwave Technol., Vol. 21, No. 1, pp. 236-45 (2003); U.S. Pat. No. 5,748,349 to Mizrahi, entitled ‘GRATINGS-BASED OPTICAL ADD-DROP MULTIPLEXERS FOR WDM OPTICAL COMMUNICATION SYSTEM,’ and U.S. Pat. No. 5,974,207 to Akysyuk et al., entitled ‘ARTICLE COMPRISING A WAVELENGTH-SELECTIVE ADD-DROP MULTIPLEXER,’ the disclosures of which are incorporated by reference herein. First generation OADM designs were limited in efficacy as they could only add/drop a fixed wavelength or waveband. Subsequent reconfigurable OADM designs are able to add/drop a selected wavelength or several wavelengths from a predetermined list of configurations. More recently, tunable OADM designs have been developed, which have the capability to add/drop a range of contiguous n channels, where n is a fixed number having a typical value of 1, 2 or 4. Recently developed systems include systems which incorporate micro-electro-mechanical (MEMS) or liquid-crystal technologies, such as wavelength selective switches (WSS) and wavelength blockers (WB). Although these systems are highly flexible in selecting arbitrary channels, they are also very expensive and can lack scalability.

In view of the foregoing, there is a need for an approach that is more flexible than existing OADM architectures and that facilitates cost-effective network deployment and upgrades.

### SUMMARY OF THE INVENTION

An improved optical add/drop multiplexer design is disclosed which can flexibly drop and add channels in an optical signal. In accordance with an embodiment, the optical add/drop multiplexer utilizes a flexible band tunable filter to select a tunable waveband of contiguous channels from the input optical signal. The optical add/drop multiplexer can then use a demultiplexer or preferably a colorless demultiplexer to separate the waveband of contiguous channels into individual dropped channels. The optical add/drop multiplexer can utilize a coupler or a multiplexer to form a second waveband from individual add channels. The optical add/drop multiplexer can then combine the second waveband with the channels in the optical signal not selected by the flexible band tunable filter to form the output optical signal. The second waveband and the unselected channels can be combined, for example, by using a coupler or a second flexible band tunable filter, tuned simultaneously with the first flexible band tunable filter. The flexible band tunable filter can be readily constructed, for example, by using two tunable edge filters which drop channels above and below edges of their respective passbands so that the intersection of their passbands defines the tunable waveband for the flexible band tunable filter. It is advantageous to insert variable optical attenuators with the tunable edge filters so as to balance the output. The colorless demultiplexer can be implemented, for example, as a cascade of interleavers or as a cyclic arrayed waveguide grating. The disclosed optical add/drop multiplexer design advantageously supports dynamic provisioning and is also rapidly tunable, polarization independent, and low-loss.

An optical add/drop modular architecture is also disclosed. The optical add/drop multiplexer comprises a plurality of modules, each module adding to the capabilities of the optical add/drop multiplexer. The modules are preferably stackable. An input optical signal is first provided to an express module, which can dynamically select a tunable waveband of contiguous channels to be processed locally by other modules in the stack—while bypassing the unselected channels directly to the output port. The selected waveband of channels is passed to a next module in the stack. Each additional module is capable of performing any of a number of functions, including providing various types of add/drop capabilities and cross-connection capabilities. For example, a simple optical add/drop module can be provided using a simple one-channel filter to drop a single channel to a drop port. A more complex and fully tunable optical add/drop module can be provided using flexible band tunable filters and corresponding colorless demultiplexers to support a full range of drop ports. Cross-connect modules can be provided which provide the ability to cross-connect with optical signals from another optical network or another stack of modules. Each module can be provided with a cascade down port to pass on portions of the optical signal for further processing by other modules, as well as a cascade up port to return an optical signal back up the stack to the express module. The express module can then combine its unselected channels with the optical signal received from the other modules in the stack to form the output optical signal. Additional modules can be stacked at the cascade down and cascade up ports of each module to provide additional capabilities to the node. Only the capabilities needed by the device owner at the present need be installed, which saves on hardware cost. When the demand for additional capabilities arrives, the upgrade can be achieved simply by stacking an additional module to the existing modules. This advantageously provides a graceful cost-effective approach for network deployment and upgrade. A stack of modules can be initially tuned to handle a small amount of add/drop channels initially. The working waveband dropped by the express module can be set for a very narrow range of channels. Then, in the future, when more channels are to be dropped or cross-connected locally, the waveband can be opened wider without disturbing the remaining express channels, while corresponding optical add/drop modules or cross connect modules can be added to the stack of modules.

These and other advantages of the invention will be apparent to those of ordinary skill in the art by reference to the following detailed description and the accompanying drawings.

### BRIEF DESCRIPTION OF DRAWINGS

FIG. 1 is schematic of an improved optical add/drop multiplexer, in accordance with an embodiment of the invention.

FIGS. 2A and 2B illustrate the principles of the tunable edge filters in a flexible band tunable filter used in an embodiment of the improved optical add/drop multiplexer.

FIGS. 3A and 3B illustrate the principles of the colorless multiplexer used in an embodiment of the improved optical add/drop multiplexer.

FIG. 4 illustrates an optical add/drop modular architecture, in accordance with another embodiment of the invention.

FIG. 5 is a schematic of an illustrative express module design.

FIG. 6 is a schematic of an illustrative fixed OADM module design.

FIG. 7 is a schematic of an illustrative tunable single-channel OADM module design.

FIG. 8 is a schematic of an illustrative tunable waveband OADM module design.

FIG. 9 is a schematic of an illustrative cross connect module design.

FIG. 10 and 11 illustrate examples of optical add/drop module stacks constructed from a variety of different modules.

### DETAILED DESCRIPTION

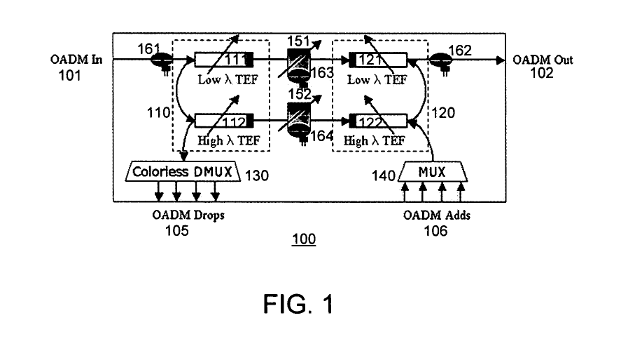

FIG. 1 is a schematic of an improved optical add/drop multiplexer (OADM) 100, in accordance with an embodiment of an aspect of the invention. The OADM 100 receives an input optical signal 101 and is advantageously capable of selectively dropping any 0 to n contiguous channels at 105 and adding the channels at 106 to form an output optical signal at 102.

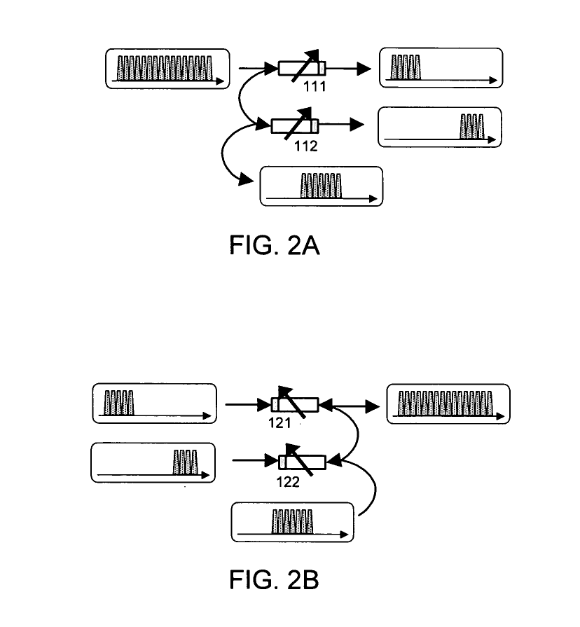

With reference to FIG. 1, the OADM 100 comprises a component 110 which the inventors refer to as a “flexible band tunable filter.” The design and operation of flexible band tunable filters is detailed in co-pending commonly-assigned U.S. patent application Ser. No. 10/810,632, entitled “FLEXIBLE BAND TUNABLE FILTER,” filed on Mar. 26, 2004, which is incorporated by reference herein. The flexible band tunable filter 110 depicted in FIG. 1 comprises a pair of what the inventors refer to as “tunable edge filters” 111, 112. Each tunable edge filter 111, 112 serves to drop a selective range of channels in the optical signal above or below an edge of their respective passbands. The pair of edge filters 111, 112 serve as the rising and falling edges of the flexible band tunable filter 110. The intersection of the passbands of the two tunable edge filters 111, 112 makes up the passband of the flexible band tunable filter 110. This is illustrated in FIG. 2A. In FIG. 2A, a tunable waveband of contiguous channels is dropped from the input optical signal by application of the first tunable edge filter 111 and the second tunable edge filter 112. The undropped channels are combined and forwarded to the output 102. The undropped channels can be combined using a coupler or, as depicted in FIG. 1, with another flexible band tunable filter 120 operating as a mirror image of the flexible band tunable filter 110. The two tunable edge filters 121, 122 in flexible band tunable filter 120 operate as a mirror image of tunable edge filters 111, 112, in the opposite path. As illustrated in FIG. 2B, a tunable waveband of contiguous channels can be added to the passed signals by the tunable edge filters 121 and 122 to construct the output optical signal. The tunable edge filter 111 in flexible band tunable filter 110 is tuned simultaneously with tunable edge filter 121 in flexible band tunable filter 120. Similarly, the tunable edge filter 112 in flexible band tunable filter 110 is tuned simultaneously with tunable edge filter 122 in flexible band tunable filter 120. Tuning these four tunable edge filters 111, 112, 121, 122 allows the dynamic selection of any single channel or multiple of adjacent channels—or it can allow the whole spectrum to be reflected with no optical signal communicated to the transmit port.

It should be noted that the order of the two tunable edge filters depicted in FIGS. 1 and 2A, 2B is not required for purposes of the invention and that the tunable edge filters can be applied in any advantageous order. Thus, the application of a tunable edge filter that passes high wavelength channels before application of a tunable edge filter that passes low wavelength channels achieves similar results to the above.

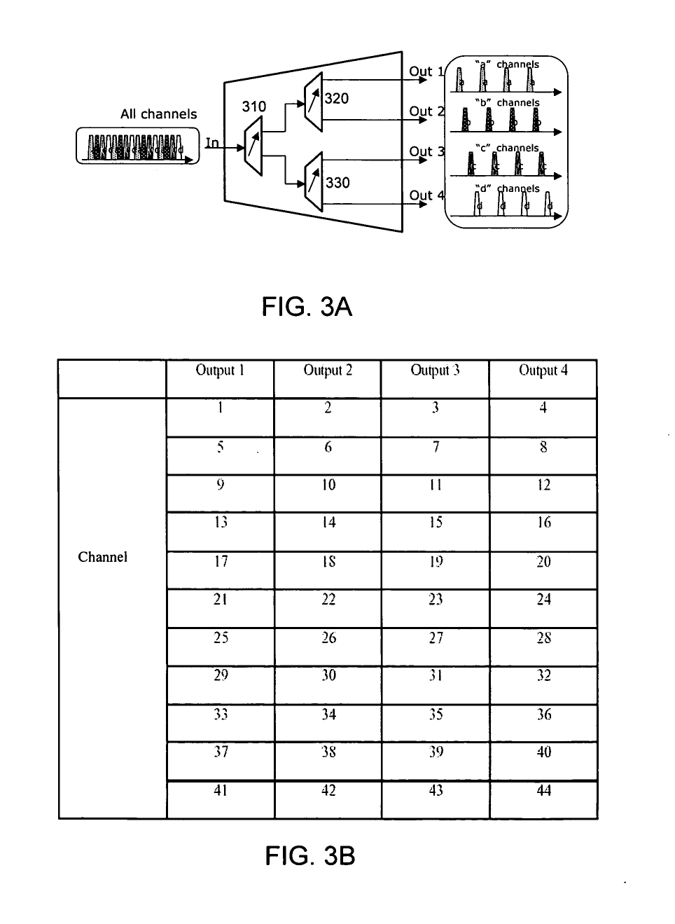

For an OADM, it is usually required to demultiplex the dropped waveband into the individual channels for local processing at the node, such as O-E conversion, amplification and regeneration. The waveband of contiguous channels produced by flexible band tunable filter 110 is demultiplexed by demultiplexer 130 into individual channels at 105. Similarly, the waveband of contiguous channels input to the flexible band tunable filter 120 is produced by a coupler or, as depicted in FIG. 1, by a multiplexer 140 which multiplexes the individual channels at 106 into a single waveband. Since the channels contained in the dropped waveband are not fixed, it is preferable to use a demultiplexer 130 which is capable of demultiplexing contiguous channels regardless of their spectral position. FIG. 3 depicts the structure of such a demultiplexer, which the inventors refer to as a “colorless demultiplexer.” As depicted in FIG. 3A, the colorless demultiplexer is implemented as a cascade of interleavers 310, 320, 330, which allows the selection of any one of four contiguous channels in a waveband. The output matrix of the four-port colorless demultiplexer is shown in FIG. 3B. Additional interleavers can be added to handle additional channels in a waveband. A configuration of interleavers with a cascade of n can divide the input spectrum into 2ⁿ groups, and therefore can separate any waveband consisting of up to 2ⁿ contiguous channels into individual channels. Alternatively, a cyclic arrayed waveguide grating with multiple ports can be utilized to perform the colorless demultiplexing. A cyclic arrayed waveguide grating with n output ports can demultiplex an input optical signal with spectral width of c2ⁿ into 2ⁿ individual channels with a channel spacing of c.

As further depicted in FIG. 1, it is advantageous to insert variable optical attenuators 151, 152 in the paths between the pairs of tunable edge filters, so as to balance the output among all channels. It is also advantageous to dispose photo-detectors 161, 162, 163, 164 at critical positions for optical monitoring.

The maximum number of channels that the OADM 100 can handle in an add/drop waveband is determined by the capabilities of the demultiplexer 130 and multiplexer 140. For example, if the OADM has a four port colorless demultiplexer, the maximum waveband size is four channels. If more than four channels are dropped and sent to the colorless demultiplexer, the channels cannot be fully demultiplexed, and some of the OADM drop outputs will contain signals from more than one channel. Thus, the drop port capabilities of the embodiment depicted in FIG. 1 are limited by the capabilities of the demultiplexer provided. Nevertheless, it is preferable to avoid the capital expense of installing multiplexers with a large port count on all OADM nodes, in particular if such add/drop capabilities are not needed until a later date. Accordingly, and in accordance with an alternative embodiment, it is advantageous to divide the OADM functionality depicted in FIG. 1 into a modular architecture that supports more dynamic add/drop requirements.

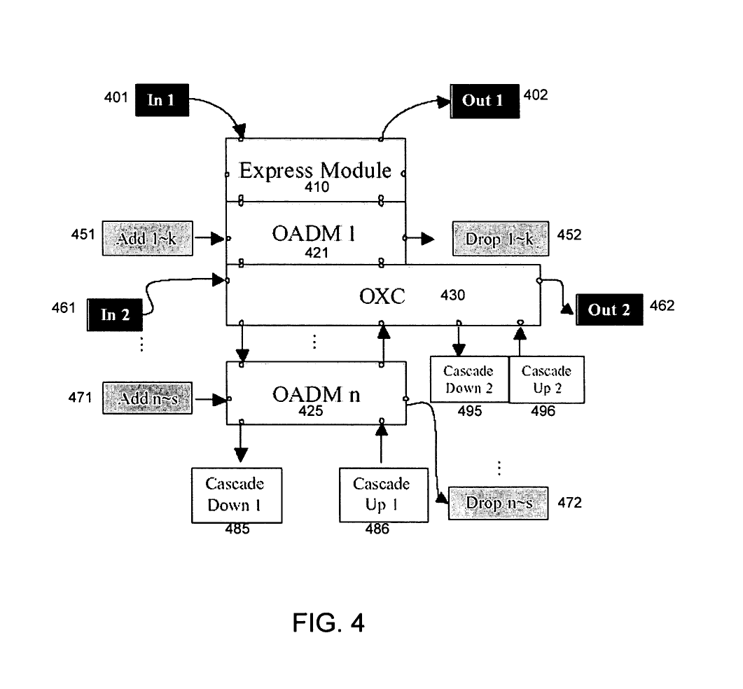

FIG. 4 illustrates such an optical add/drop modular architecture, in accordance with another embodiment of another aspect of the invention. As depicted in FIG. 4, the optical add/drop modular architecture comprises an express module 410 and any number of optical add/drop modules 421, . . . , 425. The modules are depicted as preferably stackable, although the orientation of how the modules are coupled is not important to the nature of the invention. The express module 410 provides the ports for the input optical signal 401 and the output optical signal 402 and, through its connections to the next module in the stack, can drop any number of channels for processing by the next module. The add/drop capabilities of the overall device are determined by the modules 421, . . . , 425 selected to be connected to the express module 410. Thus, optical add/drop module 421 shown in FIG. 4 has the capability to add k channels at 451 and to drop k channels at 452. On the other hand, optical add/drop module 425 shown in FIG. 4 adds the capability to add s channels at 471 and drop s channels at 472. As a further example, modules with additional capabilities, such as cross connection module 430, can be added to the stack, thereby providing the ability to cross-connect with a second input optical signal 461 and a second output optical signal 462. Additional modules can be stacked at the cascade port 485 and the cascade up port 486 in order to provide additional capabilities. Only the capabilities needed by the device owner at the present need be installed, which saves on hardware cost. When the demand for additional capabilities arrives, the upgrade can be achieved simply by stacking an additional module to the existing modules. As a result, with such a modular architecture, any channel or any number of channels can be either bypassed through the express module or be sent to the attached OADM and/or OXC modules in the stack for add/drop and cross-connection. This provides a cost-effective approach for network reconfiguration.

The operation and structure of each of the respective illustrative modules is further described below:

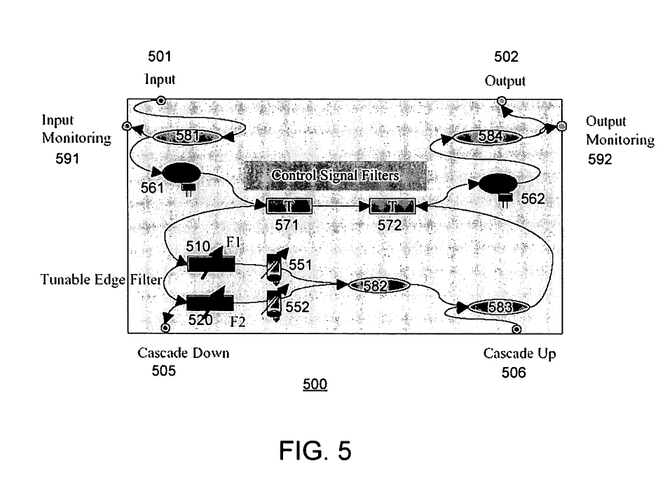

Express Module. FIG. 5 is a schematic of an illustrative express module 500. The express module 500 receives an input optical signal at an input port 501 and can dynamically select a range of contiguous channels for local processing. The unselected channels, referred to herein as the “express” channels, are bypassed directly to output port 502 without any local processing. The express module 500 preferably does not perform the local processing, such as demultiplexing or multiplexing. Rather, the express module 500 merely directs the selected channels to a cascade down port 505 coupled to another module. The express module 500 also receives the selected channels, after any local processing by other modules, at cascade up port 506 and combines the processed channels with the express channels to form an output optical signal which is directed to the output port 502.

With reference to FIG. 5, the express module 500 comprises a pair of tunable edge filters 510, 520 which, as described above, facilitate the dynamic selection of any 0 to n contiguous channels by dropping a selective range of channels above or below an edge of their respective passbands. A second pair of tunable edge filters can be disposed in the express module 500 to handle the express channels, similarly to the design set forth in FIG. 1. Alternatively, and as depicted in FIG. 5, the express channels can be combined with each other using a coupler at 582 and with the cascade up port signal at 583. Where a control signal is used in the optical signal, the control signal can be forwarded directly to the output port 502 using control signal filters 571, 572, as depicted in FIG. 5. As in the embodiment shown in FIG. 1, it is advantageous to insert variable optical attenuators 551, 552, so as to balance the output among all channels from the two tunable edge filters 510, 520. It is also advantageous for monitoring purposes to dispose photo-detectors 561, 562 at critical positions and to provide for an input monitoring port 591 and an output monitoring port 592. It should be noted that the arrangement of photo-detectors and monitoring ports depicted in FIG. 5 through 9 is somewhat arbitrary and would depend on the specific needs of the particular implementation.

The express module 500 provides the base of the modular architecture. Every modular stack includes one express module 500. The express module 500 provides the input port 501 and output port 502 of the OADM node, while all other modules connect in turn to the cascade down port 505 and the cascade up port 506 of the express module 500. Any number of contiguous channels can be selected for local processing. Any number of express channels can be bypassed. The express module 500, by bypassing the express channels, advantageously minimizes the insertion loss suffered by the express channels. The channels processed at the other modules, on the other hand, will experience larger amounts of optical loss due to more optical components in the light path.

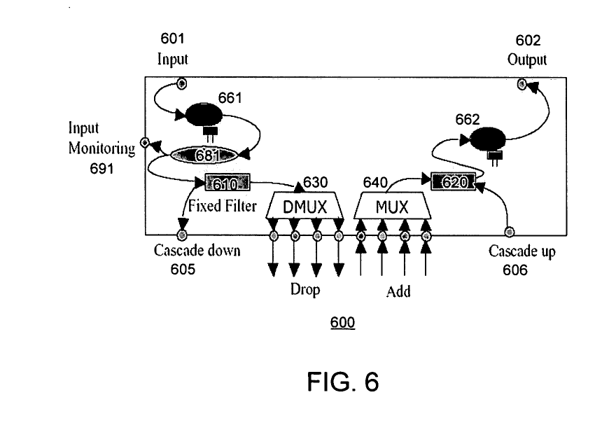

OADM Modules. FIG. 6-8 illustrate the different processing capabilities that can be facilitated by different types of OADM modules. Each OADM module has an input port and an output port which is connected to the cascade down port and the cascade up port of the next module in the stack.

FIG. 6 shows a schematic of a fixed OADM module 600 which is only capable of dropping and adding pre-selected channels. The OADM module 600 connects to the cascade down port and the cascade up port of an express module or another module at input port 601 and output port 602. The OADM module 600 comprises, for example, a pair of thin-film filters 610, 620 of either waveband filters or individual channel filters. With filters that operate on a waveband of channels, an extra demultiplexer 630 is required to further separate the dropped waveband, as depicted in FIG. 6, along with a multiplexer 640 to combine the added channels. It is advantageous to include photo-detectors 661, 662, and a monitoring port 691, for monitoring purposes as depicted in FIG. 6. Other modules can connect to the fixed OADM module 600 at cascade down port 605 and cascade up port 606.

The chief advantages of the fixed OADM module are the low insertion loss and chromatic dispersion, low cost, and easy maintenance. These advantages enable multiple fixed OADM modules to be cascaded in a node thereby providing a means of cost-effectively handling bandwidth requirements.

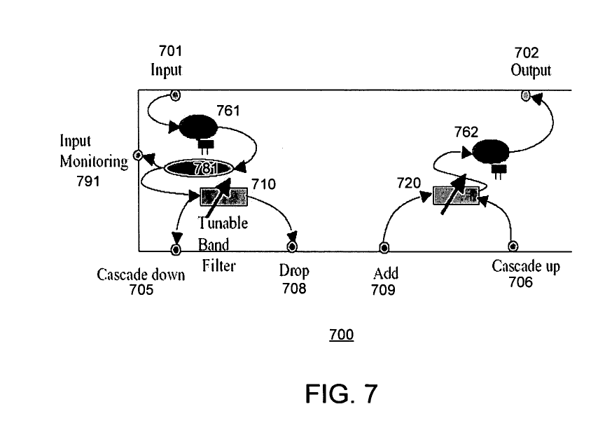

FIG. 7 depicts a schematic of a tunable single-channel OADM module 700, which provides the capability to selectively add/drop any individual channel. This OADM module 700 connects to the cascade down port and the cascade up port of an express module or another module at input port 701 and output port 702. The OADM module 700 is comprised of a pair of flexible band tunable filters 710, 720. Flexible band tunable filter 710 facilitates the dynamic selection of any single channel which is dropped at drop port 708 while the remaining channels are passed to the cascade down port 705. The OADM module 700 also provides an add port 709 and a cascade up port 706, and the flexible band tunable filter 720 (or some other component for combining the optical signals) combines the single channel at the add port 709 with the remaining channels at the cascade up port 706 to construct the output optical signal at output port 702. No demultiplexers or multiplexers are necessary for this module, since it is only designed to add/drop individual channels. It is advantageous to include photo-detectors 761, 762, and a monitoring port 791, for monitoring purposes as depicted in FIG. 7. Other modules can connect to the tunable single-channel OADM module 700 at cascade down port 705 and cascade up port 706.

The tunable single-channel OADM module 700 provides a cost-effective way to implement limited dynamic provisioning in the OADM stack. The tunable single-channel OADM module 700 can select any input wavelength according to the network configuration requirement. It can also be used to implement 1:N shared protection in case of module failure, i.e., it can tune the working channel accordingly to replace a failed OADM module. With a special mechanism, the tunable filter in the OADM module can be made ‘hitless’, meaning that that no intermediate channels will be affected during the tuning of the working wavelength.

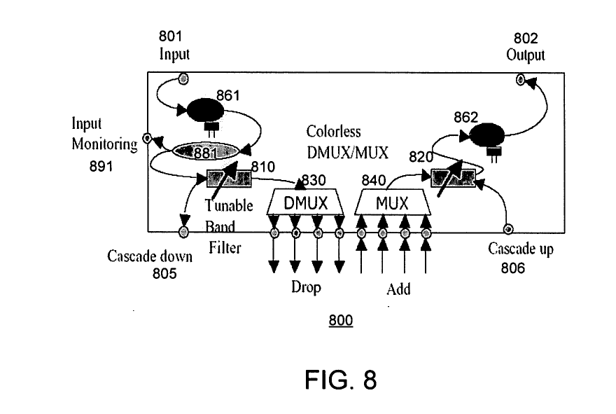

FIG. 8 depicts a schematic of a tunable waveband OADM module 800, which provides even greater flexibility in handling the channels in the optical signal. This OADM module 800 connects to the cascade down port and the cascade up port of an express module or another module at input port 801 and output port 802. The OADM module 800 again uses a pair of flexible band tunable filters 810, 820, but with a capability of handling a wider passband so as to include more channels within each filter. Flexible band tunable filter 810 facilitates the dynamic selection of any 0 to n contiguous channels in the optical signal from the input port 801. The unselected channels are passed to the cascade down port 805 while the selected channels are provided to a demultiplexer 830 which demultiplexes the waveband into individual channels. As discussed above, the demultiplexer 830 is preferably a colorless demultiplexer which is capable of demultiplexing n individual contiguous channels in a waveband regardless of their spectral position. The OADM module 800 also provides a multiplexer 840 which multiplexes individual channels at n add ports to obtain a waveband which is combined with the optical signal from the cascade up port 806 by another flexible band tunable filter 820 (or by some other component for combining the optical signals). The output optical signal constructed by the flexible band tunable filter 820 is then passed to the output port 802. It is advantageous to include photo-detectors 861, 862, and a monitoring port 891, for monitoring purposes as depicted in FIG. 8. Other modules can connect to the tunable waveband OADM module 800 at cascade down port 805 and cascade up port 806.

The tunable waveband OADM module 800 represents a more cost-effective alternative to using multiple tunable single-channel OADM modules to handle multiple channels in an OADM stack. The tunable waveband OADM module 800 significantly increases the processing capability of the OADM stack. With an appropriate routing and channel assignment scheme, it can also be used to implement 1:N shared protection to reduce the complexity of the OADM node and the inventory cost of the backup components with various working channels.

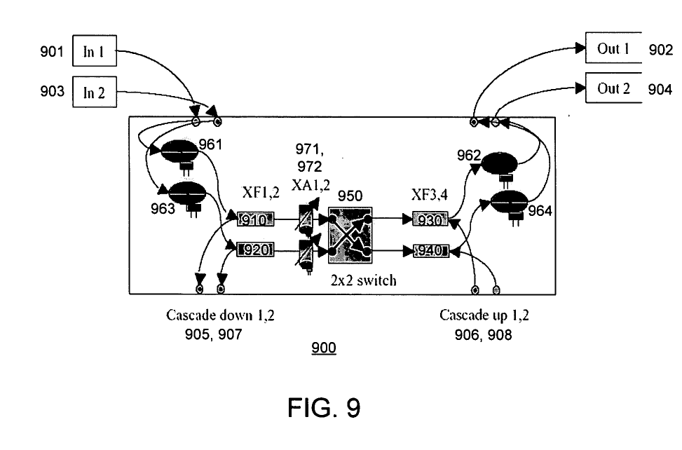

OXC Module. FIG. 9 depicts a schematic of an optical cross-connect (OXC) module 900, which can be added to the OADM stack to provide cross-connection capabilities. The OXC module 900 illustrated in FIG. 9 is a 2×2 cross-connect design. The OXC module 900 has two sets of input ports 901, 903 and output ports 902, 904. Each pair of input ports and output ports on the OXC module 900 can be used to connect to the cascade down port and the cascade up port on an express module, another module, or can be used to connect directly to an optical network. The OXC module 900 comprises a pair of filters 910, 920 which can be used to select the channels to be cross-connected, while the rest of the channels are reflected to two cascade down ports 905, 907. Similar to the above, the filter 910, 920 can be fixed or tunable and can be designed to handle a single channel or multiple channels. A 2×2 optical switch 950 is then provided which cross-connects between the two selected sets of channels. It is advantageous to insert variable attenuators 971, 972, so as to balance the output and enhance the performance. Each respective optical signal from the 2×2 optical switch 950 is combined with an optical signal from a pair of cascade up ports 906, 908 by filters 930, 940 (or by some other components for combining the optical signals such as a single filter or a coupler). The output optical signals are then passed to the output ports 902, 904. It is advantageous to include photo-detectors 961, 962, 963, 964, for monitoring purposes as depicted in FIG. 9. Other modules can connect to the OXC module 900 either to cascade down port 905 and cascade up port 906 or to cascade down port 907 and cascade up port 908. Thus, the OXC module 900 can be used to create two OADM stacks which are cross-connected at the OXC module 900.

The OXC module 900 can be used to exchange channels between two optical networks. In a mesh network with OXC nodes, restoration can be achieved to increase network robustness. It should be noted that the design depicted in FIG. 9 is not limited to 2×2 cross-connects and can be readily generalized to any number of cross-connections.

Other Modules. With the open interface of the modular architecture, other modules can be readily designed and cascaded into the OADM stack. For example, it can be advantageous to include an optical monitoring module that can be used to monitor the signal integrity in the node and the network. An optical supervisory channel (OSC) module can be used to process the data for network operation, administration, and management. It can be advantageous to include a tunable transponder module, in particular where the OADM stack uses tunable filters. The channels to be added by an OADM module should retain the same optical characteristics as the dropped channel. Rather than using multiple fixed-channel transponders that cover the entire tuning range, which poses difficulties with regard to room requirements, power consumption, and cost, it is preferable to use a transponder module that is tunable to the required channel characteristics. This can be readily implemented using an optical receiver, a widely tunable laser, and supporting electronic circuits.

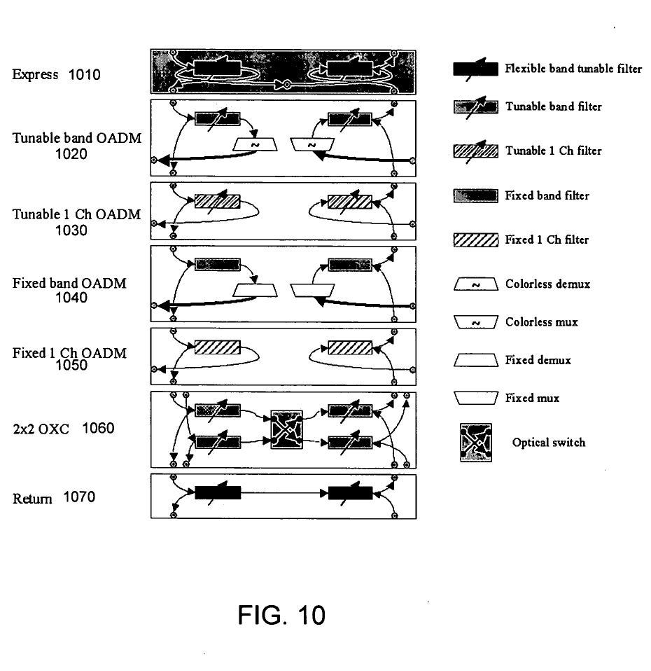

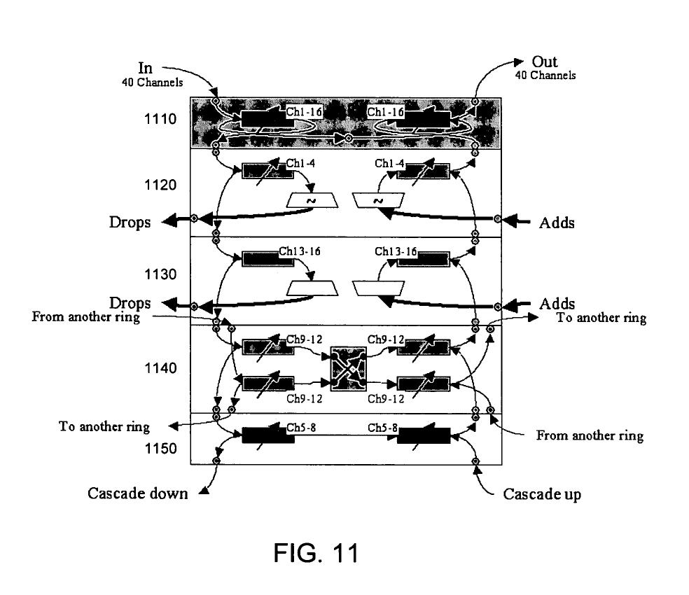

FIGS. 10 and 11 illustrate the flexibility of the modular architecture described above. In FIG. 10, an express module 1010 is provided which utilizes a flexible band tunable filter to select a first waveband of channels to pass to the next module 1020. It should be noted that this express module 1010, in contrast to the express module design depicted in FIG. 5, uses another flexible band tunable filter to combine the express channels with the cascade up optical signal from the next module 1020. The next module is a tunable waveband OADM module 1020 that uses a tunable band filter to select a second waveband of channels from the first waveband of channels. The second waveband of channels is then demultiplexed using a colorless demultiplexer and passed to drop ports, while the remaining channels are passed to the next module 1030 in the stack. The next module is a tunable single-channel OADM module 1030 which uses a tunable one-channel filter to select a channel and send it to a drop port, while the remaining channels are passed to the next module 1040 in the stack. The next module is a fixed OADM module 1040 which uses a fixed waveband filter to drop a waveband of channels which are demultiplexed by a demultiplexer to drop ports, while the remaining channels are passed to the next module 1050 in the stack. The next module is a fixed single-channel OADM module 1050 which uses a simple fixed single-channel filter to drop a single channel to a drop port while the remaining channels are passed to the next module 1060 in the stack. The next module is a 2×2 OXC module 1060, which uses a tunable band filter to select one or more channels for cross-connection with the optical signal from another optical network or another OADM stack. The remaining channels are passed to the next module 1070 in the stack, which is module referred to by the inventors as a “return” module. The return module 1070 has a structure that is similar to the express module discussed above. The return module 1070, however, is placed at the middle or bottom of the stack. It utilizes a flexible band tunable filter to select any channels that have not been already dropped or cross-connected or processed. These channels are then passed along to the cascade up port in the previous module 1060 for the return path to the express module 1010. The return module 1070 is particularly useful in the situation where the drop channels are not contiguous, although it cannot ensure the minimum loss in these channels unlike the express channels handled by the express module 1010.

In FIG. 11, a similar modular stack example is depicted, with illustrative channel selections explicitly designated. The system is assumed to be a 40 channel optical system, with a 40 channel optical signal input to the express module 1110 and a 40 channel optical signal output from the express module 1110. The express module 1110 is tuned to select channels 1 through 16 for processing by the rest of the modules. The express channels 17-40 are passed to the output port of the express module 1110. The next module is a tunable waveband OADM module 1120 which has a flexible band tunable filter and a four-port colorless demultiplexer tuned to drop channels 1 to 4. Channels 5-16 are passed to the next module which is a fixed OADM 1130. The fixed OADM 1130 has a filter and demultiplexer fixed to drop channels 13 to 16 while passing the remaining channels 5-12 to the next module. The next module is an OXC module 1140 which is tuned to cross-connect channels 9 to 12 with channels from another optical network. The remaining channels 5 through 8 are passed by the OXC module 1140 to a return module 1150 which is tuned to pass these channels up the stack. The OXC module 1040 combines these channels 5 through 8 with the channels 9 through 12 received from a source which depends on the setting of the 2×2 cross-connect. The OXC module 1140 passes the combined waveband of channels 5 through 12 to the fixed OADM 1130. The fixed OADM 1130 multiplexes channels 13 through 16 and adds the multiplexed channels to the waveband of channels 5 through 12 to create a waveband of channels 5 through 16. The tunable waveband OADM module 1120 uses a multiplexer to multiplex channels 1 through 4 and then proceeds to combine the waveband with the waveband of channels 5 through 16. The express module 1110 receives this optical signal, combines channels 1 through 16 with the express channels to construct the output optical signal of 40 channels.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations which, although not explicitly shown or described herein, embody the principles of the invention and are within their spirit and scope.

1. An optical add/drop multiplexer comprising:
a flexible band tunable filter which receives an input optical signal and which selectively drops a tunable waveband of contiguous channels from the input optical signal; and
a demultiplexer coupled to the flexible band tunable filter which receives the dropped waveband and separates the dropped waveband into individual dropped channels.

2. The optical add/drop multiplexer of claim 1 wherein the flexible band tunable filter further comprises a first and second tunable edge filter, the first tunable edge filter adapted to drop channels above an edge of its passband and the second tunable edge filter adapted to drop channels below an edge of its passband so that an intersection of the passbands of the first and second tunable edge filters defines the tunable waveband for the flexible band tunable filter.

3. The optical add/drop multiplexer of claim 2 wherein variable optical attenuators are coupled to the first and second tunable edge filters so as to balance output of the tunable edge filters.

4. The optical add/drop multiplexer of claim 1 wherein the demultiplexer is a colorless demultiplexer.

5. The optical add/drop multiplexer of claim 4 wherein the colorless demultiplexer further comprises a cascade of interleavers.

6. The optical add/drop multiplexer of claim 4 wherein the colorless demultiplexer further comprises a cyclic arrayed waveguide grating.

7. The optical add/drop multiplexer of claim 1 wherein channels unselected by the flexible band tunable filter are combined with a waveband of add channels to form an output optical signal.

8. The optical add/drop multiplexer of claim 7 further comprising a coupler which combines individual add channels to form the waveband of add channels.

9. The optical add/drop multiplexer of claim 7 further comprising a multiplexer, wherein the multiplexer receives individual add channels and combines the individual add channels to form the waveband of add channels.

10. The optical add/drop multiplexer of claim 7 further comprising a second flexible band tunable filter which is tuned with the first flexible band tunable filter and which combines the unselected channels with the add waveband to form the output optical signal.

11. A modular optical add/drop architecture comprising:
an express module which receives an input optical signal and selectively drops a tunable waveband of channels in the input optical signal while passing unselected channels to an output optical signal; and
one or more optical add/drop modules coupled to the express module which receive the tunable waveband and which select one or more channels in the tunable waveband for forwarding to one or more drop ports, wherein the optical add/drop modules can be selectively decoupled and recoupled with the express module to change capabilities of the modular optical add/drop architecture.

12. The modular optical add/drop architecture of claim 11 wherein the optical add/drop modules can receive channels from one or more add ports and multiplex the channels into an add waveband that can be passed to the express module, the express module combining the add waveband with the unselected channels to form the output optical signal.

13. The modular optical add/drop architecture of claim 11 wherein the express module further comprises a flexible band tunable filter to selectively drop the tunable waveband.

14. The modular optical add/drop architecture of claim 11 wherein at least one of the add/drop modules further comprises a colorless demultiplexer.

15. The modular optical add/drop architecture of claim 11 further comprising an optical cross-connect module which cross-connects the tunable waveband with a second tunable waveband from another optical signal.

16. The modular optical add/drop architecture of claim 11 wherein the modules are stackable.

17. A modular optical add/drop architecture comprising one or more modules, at least one module of which comprises:
an input port;
an output port;
a cascade down port; and
a flexible band tunable filter which selectively drops a tunable waveband of channels from an optical signal received at the input port and forwards the tunable waveband to the cascade down port while passing unselected channels to the output port;
wherein the cascade down port is adapted to couple to other modules in the modular optical add/drop architecture which can further process the tunable waveband.

18. The module of claim 17 further comprising a cascade up port which is adapted to couple to other modules in the modular optical add/drop architecture and which receives a waveband of add channels from the other modules which is combined with the unselected channels and passed to the output port.

19. The module of claim 17 wherein the flexible band tunable filter further comprises a first and second tunable edge filter, the first tunable edge filter adapted to drop channels above an edge of its passband and the second tunable edge filter adapted to drop channels below an edge of its passband so that an intersection of the passbands of the first and second tunable edge filters defines the tunable waveband for the flexible band tunable filter.

20. The module of claim 18 wherein the module is stackable with the other modules such that the cascade down port and the cascade up port couple respectively to an input port and an output port on a next module in a stack.
